(19) United States
(12) Patent Application Publication
(10) Pub. No.: US 2025/0251077 A1
(43) Pub. Date: Aug. 7, 2025

(54) MAGNETIC MOUNT FOR ELECTRONIC DEVICE

(71) Applicant: SHENZHEN MAIGU TECHNOLOGY CO., LTD., SHENZHEN (CN)

(72) Inventor: HAINING HOU, SHENZHEN (CN)

(21) Appl. No.: 19/190,049

(22) Filed: Apr. 25, 2025

Related U.S. Application Data
(63) Continuation of application No. PCT/CN2023/126592, filed on Oct. 25, 2023.

(30) Foreign Application Priority Data
Oct. 25, 2022 (CN) 202222819211.0

(51) Int. Cl. F16M 11/12; F16M 11/04

(52) U.S. Cl. CPC F16M 11/125; F16M 11/041

(57) ABSTRACT

A magnetic mount for an electronic device is provided, the magnetic mount comprises a magnetic assembly, a connecting assembly and a support, the magnetic assembly is configured to adsorb and connect the electronic device, the connecting assembly is configured to connect the magnetic assembly and the support, the support is configured to support the electronic device, the magnetic assembly is rotatably connected with the connecting assembly for adjusting the rotation angle of the electronic device, and the support is hinged with the connecting assembly for adjusting the inclination angle of the electronic device.

### CROSS-REFERENCE TO RELATED APPLICATIONS

This application is a continuation application of the international patent application No. PCT/CN2023/126592, filed on Oct. 25, 2023 and claims priority of Chinese patent application No. 202222819211.0, filed on Oct. 25, 2022. Contents of which are incorporated herein by their entireties.

### TECHNICAL FIELD

The present disclosure relates to the technical field of mounts for electronic devices, and in particular, relates to a magnetic mount for electronic devices.

### BACKGROUND

With the development of science and technology, electronic devices such as mobile phones and tablet computers have been widely used in daily life. These electronic devices such as mobile phones and tablet computers have the advantage of being portable, but when they are used for activities like watching movies or reading, they are inconvenient to prop up due to the lack of support points.

Therefore, floor stands, cantilever desktop stands, vehicle navigation mounts or the like are commonly provided to prop up electronic devices such as mobile phones and tablet computers so that these electronic devices can be positioned at various inclination angles to facilitate the use in activities such as watching movies or reading.

However, the stands currently available are not convenient to adjust the rotation and inclination angles of electronic devices such as mobile phones and tablet computers and thus cause poor user experience.

### SUMMARY

A main technical problem to be solved by the present disclosure is to provide a magnetic mount for electronic devices, which solves the problem that the user experience for the stands currently available is poor because it is not convenient to adjust the rotation and inclination angles of electronic devices such as mobile phones and tablet computers.

In order to solve the above technical problem, a technical solution adopted by the present disclosure is to provide a magnetic mount for an electronic device which comprises a magnetic assembly, a connecting assembly and a support, the magnetic assembly is configured to adsorb and connect the electronic device, the connecting assembly is configured to connect the magnetic assembly and the support, the support is configured to support the electronic device, the magnetic assembly is rotatably connected with the connecting assembly for adjusting the rotation angle of the electronic device, and the support is hinged with the connecting assembly for adjusting the inclination angle of the electronic device.

Preferably, the magnetic assembly comprises an mounting piece, a magnetic piece and a cover piece, wherein one side of the mounting piece is provided with a groove, the magnetic piece is arranged in the groove, and the cover piece is connected with the mounting piece and covers the outside of the magnetic piece.

Preferably, the magnetic piece is adapted to the shape of the groove, and the magnetic piece is an annular magnet.

Preferably, the connecting assembly comprises a connecting main member, which comprises a main part, a first connecting part extending outwards from the center of the main part, and a second connecting part penetrating through the main part radially; the first connecting part is configured to rotatably connect the mounting piece, and the second connecting part is configured to be hinged with the support.

Preferably, a rotating shaft passes through the second connecting part, a sleeve is sleeved outside the rotating shaft, and the sleeve is adapted to the second connecting part.

Preferably, the connecting main member at both ends of the second connecting part is further provided with a joining part, the hinged end of the support is provided with a limiting part adapted to the joining part, and the limiting part is matched with the joining part for limiting the rotation angle of the support relative to the connecting main member.

Preferably, the connecting main member further comprises a sealing part, an elastic sheet is arranged in the sealing part, one end of the elastic sheet abuts against the surface of the mounting piece, and a plurality of protrusions circumferentially arranged uniformly are provided on the mounting piece at the position corresponding to the elastic sheet.

Preferably, the elastic sheet comprises a parallel part parallel to the mounting piece, a vertical part perpendicular to the mounting piece, and a bending part connecting the parallel part and the vertical part; the parallel part is configured to fix the elastic sheet, and the lower end of the vertical part abuts against the surface of the mounting piece.

Preferably, the free end of the support is recessed inward to form an accommodating groove, a movable blade is arranged in the accommodating groove, a sealing cover is arranged outside the blade, and the sealing cover is configured to cover the blade.

Preferably, the sealing cover is slidably connected with a slider, the slider comprises a sliding part slidably connected with the sealing cover, a fixing part extending from the middle of the sliding part, and an abutting part extending from the upper side of the sliding part; the fixing part is configured to fix the blade; the sealing cover is internally provided with a fixed shaft, the outer side of the fixed shaft is sleeved with a torsion spring, one protruding end of the torsion spring penetrates through a through via at the center of the abutting part, and the other protruding end abuts against the inner wall of the sealing cover.

Beneficial effects of the present disclosure are as follows: in the present disclosure, the electronic device can be conveniently adsorbed by the magnetic assembly, which is convenient for the installation of the electronic device; after the installation is completed, the rotational connection between the magnetic assembly and the connection assembly enables the magnetic assembly to rotate with respect to the connecting assembly so that the electronic device adsorbed on the magnetic assembly can be rotated conveniently at various rotation angles. The inclination angle of the connecting assembly relative to the support can also be adjusted through the hinged connection between the support and the connecting assembly so that the electronic device has various inclination angles. Therefore, the rotation and inclination angles of the electronic device can be conveniently adjusted, thereby improving the user experience.

### BRIEF DESCRIPTION OF THE DRAWINGS

FIG. 1 is a schematic structural diagram of an embodiment of a magnetic mount for an electronic device according to the present disclosure.

FIG. 2 is a schematic structural diagram of the front side of an embodiment of a magnetic mount for an electronic device according to the present disclosure.

FIG. 3 is a schematic structural diagram of an embodiment of a magnetic mount for an electronic device when it is deployed according to the present disclosure.

FIG. 4 is a schematic exploded structural diagram of an embodiment of a magnetic mount for an electronic device according to the present disclosure.

FIG. 5 is a schematic structural diagram of a connecting main member of an embodiment of a magnetic mount for an electronic device according to the present disclosure.

FIG. 6 is a schematic structural diagram of a support of an embodiment of a magnetic mount for an electronic device according to the present disclosure.

FIG. 7 is a partially enlarged structural diagram at A in FIG. 6.

FIG. 8 is a schematic structural diagram of the rear part of a mounting piece of an embodiment of a magnetic mount for an electronic device according to the present disclosure.

FIG. 9 is a schematic structural diagram of the front part of a mounting piece of an embodiment of a magnetic mount for an electronic device according to the present disclosure. FIG. 10 is a schematic structural diagram of the interior of a sealing cover of an embodiment of a magnetic mount for an electronic device according to the present disclosure.

FIG. 11 is a schematic structural diagram of a slider of an embodiment of a magnetic mount for an electronic device according to the present disclosure.

### DETAILED DESCRIPTION

In order to facilitate the understanding of the present disclosure, the present disclosure will be described in more detail hereinafter with reference to the attached drawings and specific embodiments. Preferred embodiments of the present disclosure are given in the attached drawings. However, the present disclosure can be realized in many different forms and is not limited to the embodiments described in this specification. On the contrary, these embodiments are provided to make the understanding of the disclosure of the present disclosure more thorough and comprehensive.

It shall be noted that, unless otherwise defined, all technical and scientific terms used in this specification have the same meanings as those commonly understood by those skilled in the art of the present disclosure. The terms used in the specification of the present disclosure are only for the purpose of describing specific embodiments, and are not intended to limit the present disclosure. The term “and/or” as used in this specification includes any and all combinations of one or more associated items listed.

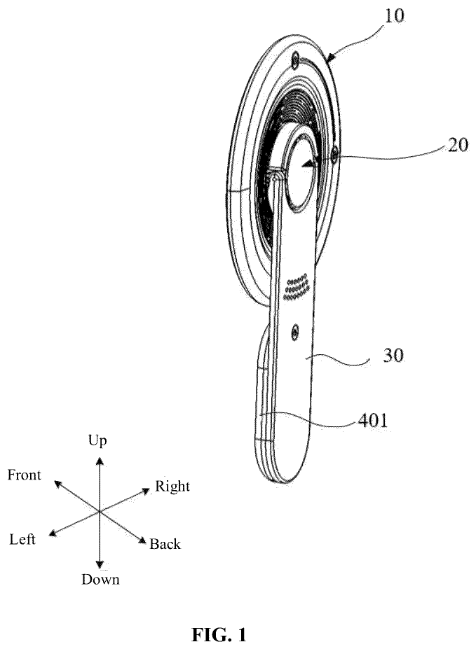

For the description of the present disclosure, labels “front”, “back”, “up”, “down”, “left” and “right” shown in FIG. 1 are used in a non-limiting way to promote the understanding of this embodiment, and are not intended to limit the present disclosure. The front-back direction indicates the horizontal direction, the left-right direction indicates the longitudinal direction, and the up-down direction indicates the vertical direction.

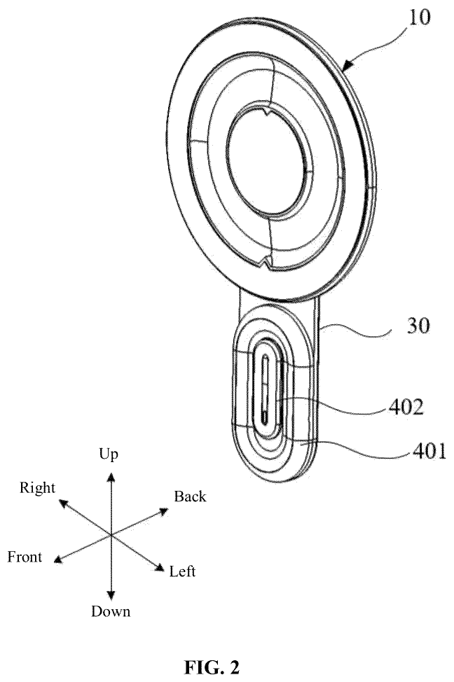

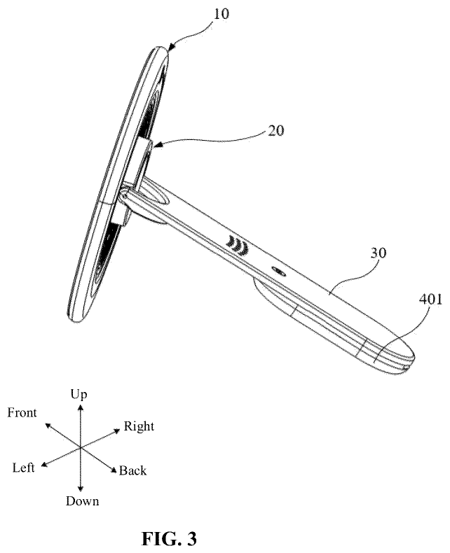

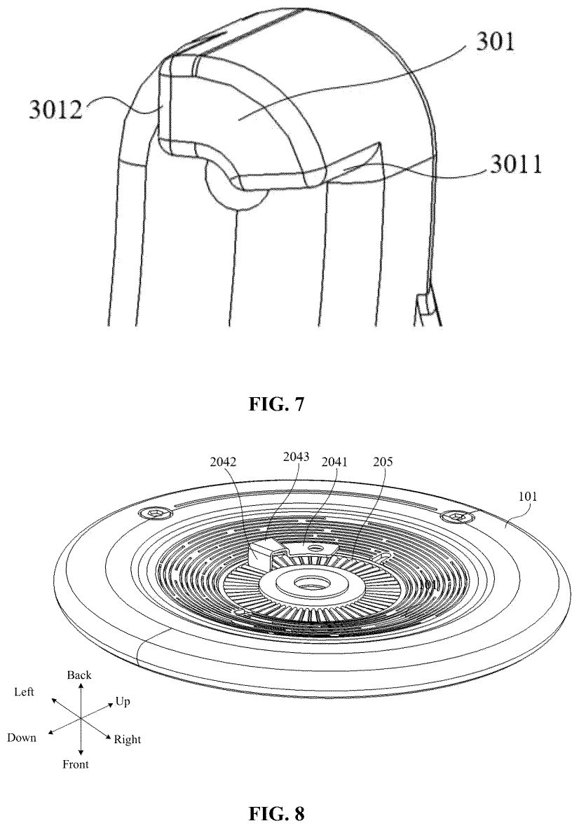

FIG. 1 to FIG. 11 show an embodiment of a magnetic mount for an electronic device according to the present disclosure, which comprises a magnetic assembly 10, a connecting assembly 20 and a support 30, wherein the magnetic assembly 10 is configured to adsorb and connect the electronic device, the connecting assembly 20 is configured to connect the magnetic assembly 10 and the support 30, the support 30 is configured to support the electronic device, the magnetic assembly 10 is rotatably connected with the connecting assembly 20 for adjusting the rotation angle of the electronic device, and the support 30 is hinged with the connecting assembly 20 to adjust the inclination angle of the electronic device.

In the present disclosure, the electronic device can be conveniently adsorbed by the magnetic assembly 10, which is convenient for the installation of the electronic device; after the installation is completed, the rotational connection between the magnetic assembly 10 and the connection assembly 20 enables the magnetic assembly 10 to rotate with respect to the connecting assembly 20 so that the electronic device adsorbed on the magnetic assembly 10 can be rotated conveniently at various rotation angles. The inclination angle of the connecting assembly 20 relative to the support 30 can also be adjusted through the hinged connection between the support 30 and the connecting assembly 20 so that the electronic device has various inclination angles. Therefore, the rotation and inclination angles of the electronic device can be conveniently adjusted, thereby improving the user experience.

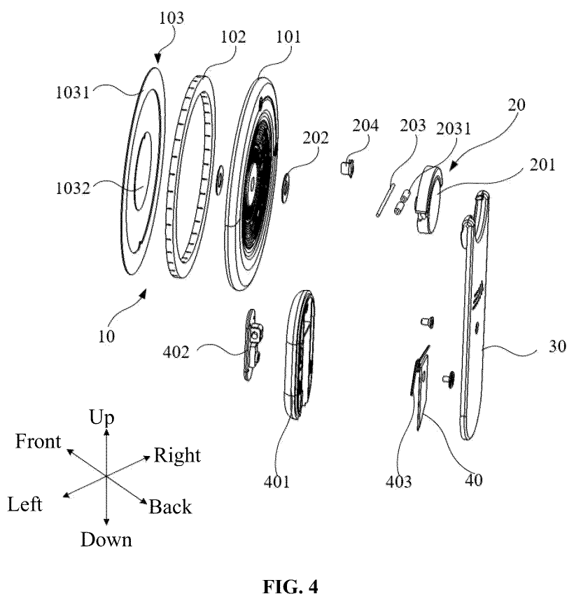

Preferably, as shown in FIG. 4, the magnetic assembly 10 comprises an mounting piece 101, a magnetic piece 102 and a cover piece 103, wherein one side of the mounting piece 101 is provided with a groove 1011, the magnetic piece 102 is arranged in the groove 1011, and the cover piece 103 is connected with the mounting piece 101 and covers the outside of the magnetic piece 102.

Preferably, as shown in FIG. 4, the mounting piece 101 has a disc shape, and the groove 1011 is annularly arranged at the edge of the mounting piece 101. At the center of the mounting piece 101 is an adapter part 1012 for connecting the connecting assembly 20. Preferably, the front part of the adapter part 1012 protrudes outward, while the rear part thereof is recessed.

The magnetic piece 102 refers to any magnet or metal that can attract magnets such as ferrite magnets, aluminum-nickel-cobalt alloy magnets, rare earth magnets or the like.

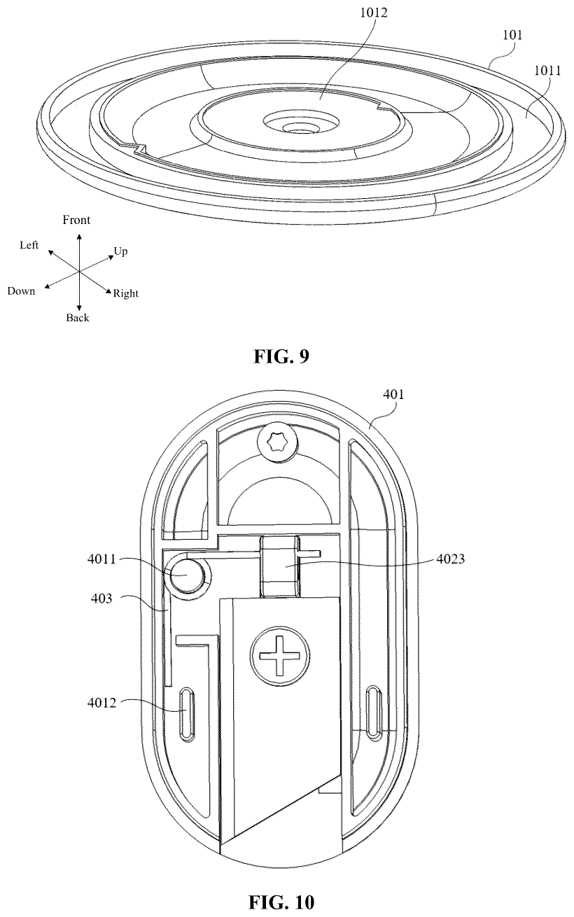

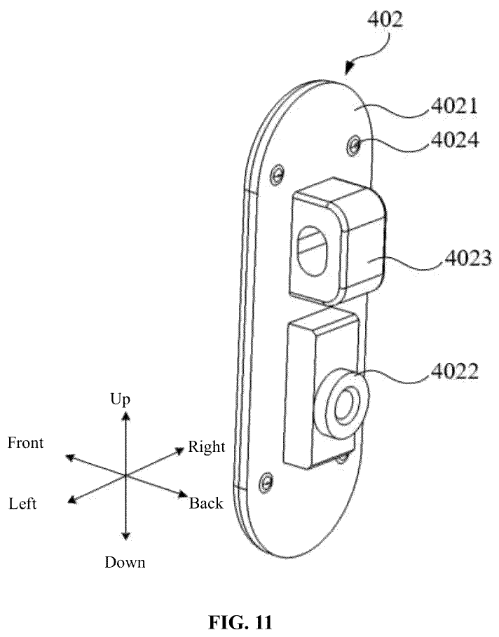

Preferably, as shown in FIG. 4 and FIG. 9, the magnetic piece 102 is adapted to the shape of the groove 1011, and the magnetic piece 102 is an annular magnet which is arranged in the groove 1011. The magnet piece is attached to the back cover of the electronic device via a magnet, and the electronic device may be mobile phones and tablet computers or the like. When the back cover of the electronic device cannot be adsorbed, an iron sheet or the like may be attached to the back cover of the electronic device, and then the back cover can be adsorbed by the magnetic piece 102.

Preferably, as shown in FIG. 4, the cover piece 103 includes a first cover part 1031 adapted to the groove 1011 and a second cover part 1032 adapted to the adapter part 1012. The first cover part 1031 covers the outside of the groove 1011 to prevent the magnetic piece 102 from falling out, and the second cover part 1032 covers the adapter part 1012 to prevent the joint between the magnetic assembly 10 and the connecting assembly 20 from being exposed.

Preferably, as shown in FIG. 4, the connecting assembly 20 includes a connecting main member 201, and the connecting main member 201 includes a main part 2011, a first connecting part 2012 extending outwards from the center of the main part 2011, and a second connecting part 2013 penetrating through the main part 2011 radially, wherein the first connecting part 2012 is used to rotatably connect the mounting piece 101 and the second connecting part 2013 is used to be hinged with the support 30.

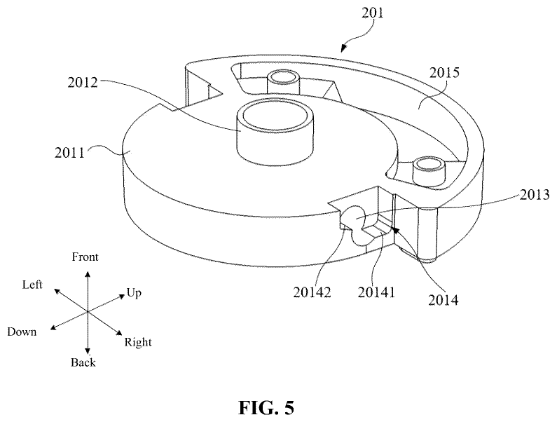

Preferably, as shown in FIG. 5, the first connecting part 2012 is a ring-shaped protrusion, and the first connecting part 2012 penetrates into the adapter part 1012 of the mounting plate and is rotatably connected with the mounting piece 101. In this way, the connecting main member 201 and the support 30 hinged thereto can be rotated by 0° to 360° relative to the mounting piece 101.

Preferably, as shown in FIG. 4, both ends of the first connecting part 2012 are provided with gaskets 202, and the two gaskets 202 are located on both sides of the mounting piece 101 respectively, so that the stability of the connection between the first connecting part 2012 and the mounting piece 101 can be improved.

Preferably, as shown in FIG. 4, the second connecting part 2013 is a circular through via, a rotating shaft 203 passes through the second connecting part 2013, and both ends of the rotating shaft 203 are hinged with the support 30.

Preferably, as shown in FIG. 4, a sleeve 2031 is sleeved outside the rotating shaft 203, and the sleeve 2031 is adapted to the second connecting part 2013. This design can facilitate the rotation of the rotating shaft 203 to enhance the damping, thereby improving the service life.

Preferably, the fit between the sleeve 2031 and the second connecting part 2013 is transition fit, and the tolerance of transition fit is preferably H6/k5. When the external force is less, there is a certain friction between the sleeve 2031 and the second connecting part 2013 to avoid the rotation of the sleeve 2031, and when there is a certain external force, the sleeve 2031 can be rotated relative to the second connecting part 2013 by the external force, so that the support 30 can be rotated at any angle relative to the connecting main member 201. Thus, when the electronic device is supported by the support 30, the electronic device can be inclined at various angles.

Preferably, as shown in FIG. 5, the connecting main member 201 at both ends of the second connecting part 2013 is further provided with a joining part 2014, the hinged end of the support 30 is provided with a limiting part 301 adapted to the joining part 2014, and the limiting part 301 is matched with the joining part 2014 for limiting the rotation angle of the support 30 relative to the connecting main member 201. The rotation angle of the support 30 relative to the connecting main member 201 is 0° to 85°.

Preferably, as shown in FIG. 5, the joining part 2014 includes a first limiting surface 20141 and a second limiting surface 20142 located on both sides of the second connecting part 2013. The limiting part 301 is fan-shaped and includes a first side surface 3011 and a second side surface 3012 on both sides of the fan-shaped surface. When the angle between the support 30 and the connecting main member 201 is 0°, the first side surface 3011 abuts against the first limiting surface 20141. When the angle between the support 30 and the connecting main member 201 is 85°, the second side surface 3012 abuts against the second limiting surface 20142. Thus, the inclination angle of the support 30 relative to the connecting main member 201 is limited to 0° to 85°.

Further speaking, as shown in FIG. 4 and FIG. 5, the connecting main member 201 further includes a sealing part 2015, an elastic sheet 204 is arranged in the sealing part 2015, one end of the elastic sheet 204 abuts against the surface of the mounting piece 101, and a plurality of protrusions 205 circumferentially arranged uniformly are provided on the mounting piece 101 at the position corresponding to the elastic sheet 204. The protrusion 205 adjacent to the elastic sheet 204 is parallel or nearly parallel to the elastic sheet 204. When the connecting main member 201 rotates, the elastic sheet 204 rotates accordingly, and when the elastic sheet 204 rotates, it touches the protrusion 205 and makes a mechanical click sound. Therefore, when the connecting main member 201 rotates, it has a sound prompt, and this sound has the effect of relieving mental stress.

Preferably, as shown in FIG. 8, the elastic sheet 204 comprises a parallel part 2041 parallel to the mounting piece 101, a vertical part 2042 perpendicular to the mounting piece 101, and a bending part 2043 connecting the parallel part 2041 and the vertical part 2042. The parallel part 2041 may be fixed in the sealing part 2015 of the connecting main member 201 by means of riveting. The lower end of the vertical part 2042 abuts against the surface of the mounting piece 101. The bending part 2043 connects the parallel part 2041 and the vertical part 2042, which can improve the elasticity of the elastic sheet 204. This facilitates the rotation of the elastic sheet 204 along with the connecting main member 201.

Preferably, the cross section of the protrusion 205 is arc-shaped. This may prevent the protrusion 205 from jamming the elastic sheet 204.

Preferably, as shown in FIG. 10, the free end of the support 30 is recessed inward to form an accommodating groove 302, a movable blade 40 is arranged in the accommodating groove 302, a sealing cover 401 is arranged outside the blade 40, and the sealing cover 401 is used to cover the blade 40.

Preferably, as shown in FIG. 11, the sealing cover 401 is slidably connected with a slider 402, the slider 402 comprises a sliding part 4021 slidably connected with the sealing cover 401, a fixing part 4022 extending from the middle of the sliding part 4021, and an abutting part 4023 extending from the upper side of the sliding part 4021, and the fixing part 4022 is used to fix the blade 40. The sealing cover 401 is internally provided with a fixed shaft 4011, and the outer side of the fixed shaft 4011 is sleeved with a torsion spring 403, one protruding end of the torsion spring 403 penetrates through a through via at the center of the abutting part 4023, and the other protruding end abuts against the inner wall of the sealing cover 401.

When an external force is applied to push the slider 402, it overcomes the elastic force of the torsion spring 403, and the slider 402 drives the end of the blade 40 to extend outward, so that the blade 40 can be used for cutting external objects, for example for unpacking parcels. When the external force disappears, the elastic force of the torsion spring 403 brings the blade 40 into the accommodating groove 302 to prevent the blade 40 from being exposed.

The sealing cover 401 may be connected with the support 30 in a snap-fit manner.

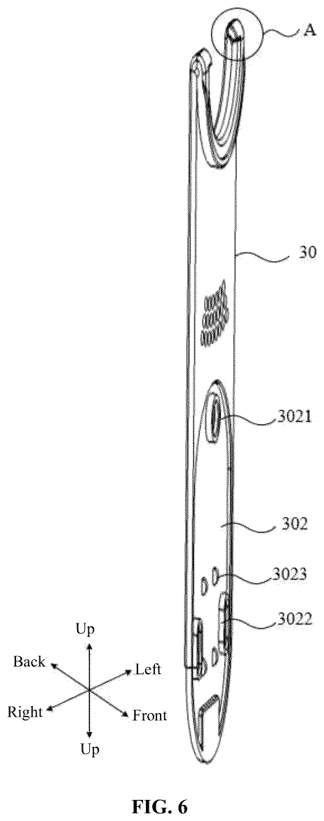

Preferably, as shown in FIG. 6, a threaded boss 3021 protrudes from one end of the accommodating groove 302 and a recessed buckle platform 3022 protrudes from the other end. The sealing cover 401 is provided with a threaded hole corresponding to the threaded boss 3021 and a raised buckle 4012 corresponding to the recessed buckle platform 3022, and the threaded boss 3021 is connected with the threaded hole by a bolt. The raised buckle 4012 snaps into the recessed buckle platform 3022, thereby connecting the sealing cover 401 with the support 30.

Preferably, as shown in FIG. 6, a plurality of arc-shaped platforms 3023 protrude from the accommodating groove 302 at the position corresponding to the blade 40, and the blade 40 may be supported by the arc-shaped platforms 3023 to slide in and out conveniently.

Preferably, as shown in FIG. 11, sliding beads 4024 extend inward from all four corners of the slider 402, and the sliding beads 4024 abut against the surface of the sealing cover 401, thereby facilitating the sliding of the slider 402 relative to the sealing cover 401.

As can be seen from the above description, the present disclosure discloses a magnetic mount for an electronic device, which can conveniently absorb the electronic device through the magnetic assembly and facilitate the installation of the electronic device; after the installation is completed, the rotational connection between the magnetic assembly and the connection assembly enables the electronic device to have various rotation angles. The hinged connection between the support and the connecting assembly enables the electronic device to have various inclination angles. The mechanical click sound emitted from the elastic sheet has the effect of relieving mental stress. The arrangement of the blade increases the use of the mount, and improves the convenience of use.

What described above are only the embodiments of the present disclosure, but are not intended to limit the scope of the present disclosure. Any equivalent structures modifications that are made according to the specification and the attached drawings of the present disclosure, or any direct or indirect applications of the present disclosure in other related technical fields shall all be covered within the scope of the present disclosure.

What is claimed is:

1. A magnetic mount for an electronic device, being characterized in that, comprising a magnetic assembly, a connecting assembly and a support, the magnetic assembly being configured to adsorb and connect the electronic device, the connecting assembly being configured to connect the magnetic assembly and the support, the support being configured to support the electronic device, the magnetic assembly being rotatably connected with the connecting assembly for adjusting the rotation angle of the electronic device, and the support being hinged with the connecting assembly for adjusting the inclination angle of the electronic device.

2. The magnetic mount for the electronic device according to claim 1, being characterized in that, the magnetic assembly comprises an mounting piece, a magnetic piece and a cover piece, wherein one side of the mounting piece is provided with a groove, the magnetic piece is arranged in the groove, and the cover piece is connected with the mounting piece and covers the outside of the magnetic piece.

3. The magnetic mount for the electronic device according to claim 2, being characterized in that, the magnetic piece is adapted to the shape of the groove, and the magnetic piece is an annular magnet.

4. The magnetic mount for the electronic device according to claim 2, being characterized in that, the connecting assembly comprises a connecting main member, which comprises a main part, a first connecting part extending outwards from the center of the main part, and a second connecting part penetrating through the main part radially; the first connecting part is configured to rotatably connect the mounting piece, and the second connecting part is configured to be hinged with the support.

5. The magnetic mount for the electronic device according to claim 4, being characterized in that, a rotating shaft passes through the second connecting part, a sleeve is sleeved outside the rotating shaft, and the sleeve is adapted to the second connecting part.

6. The magnetic mount for the electronic device according to claim 5, being characterized in that, the connecting main member at both ends of the second connecting part is further provided with a joining part, the hinged end of the support is provided with a limiting part adapted to the joining part, and the limiting part is matched with the joining part for limiting the rotation angle of the support relative to the connecting main member.

7. The magnetic mount for the electronic device according to claim 6, being characterized in that, the connecting main member further comprises a sealing part, an elastic sheet is arranged in the sealing part, one end of the elastic sheet abuts against the surface of the mounting piece, and a plurality of protrusions circumferentially arranged uniformly are provided on the mounting piece at the position corresponding to the elastic sheet.

8. The magnetic mount for the electronic device according to claim 7, being characterized in that, the elastic sheet comprises a parallel part parallel to the mounting piece, a vertical part perpendicular to the mounting piece, and a bending part connecting the parallel part and the vertical part; the parallel part is configured to fix the elastic sheet, and the lower end of the vertical part abuts against the surface of the mounting piece.

9. The magnetic mount for the electronic device according to claim 1, being characterized in that, the free end of the support is recessed inward to form an accommodating groove, a movable blade is arranged in the accommodating groove, a sealing cover is arranged outside the blade, and the sealing cover is configured to cover the blade.

10. The magnetic mount for the electronic device according to claim 9, being characterized in that, the sealing cover is slidably connected with a slider, the slider comprises a sliding part slidably connected with the sealing cover, a fixing part extending from the middle of the sliding part, and an abutting part extending from the upper side of the sliding part; the fixing part is configured to fix the blade; the sealing cover is internally provided with a fixed shaft, the outer side of the fixed shaft is sleeved with a torsion spring, one protruding end of the torsion spring penetrates through a through via at the center of the abutting part, and the other protruding end abuts against the inner wall of the sealing cover.
